(19) United States
(12) Patent Application Publication
(10) Pub. No.: US 2025/0013118 A1
(43) Pub. Date: Jan. 9, 2025

(54) ELECTRO-OPTICAL ELEMENT, LIGHT SOURCE MODULE, OPTICAL ENGINE, AND XR GLASSES

(71) Applicant: TDK CORPORATION, Tokyo (JP)

(72) Inventors: Hiroki HARA, Tokyo (JP); Yasuhiro Takagi, Tokyo (JP)

(73) Assignee: TDK CORPORATION, Tokyo (JP)

(21) Appl. No.: 18/738,630

(22) Filed: Jun. 10, 2024

(30) Foreign Application Priority Data
Jul. 5, 2023 (JP) 2023-110881

(51) Int. Cl. G02F 1/21; G02F 1/03; G02F 1/035

(52) U.S. Cl. CPC G02F 1/212; G02F 1/0327; G02F 1/0338; G02F 1/035; G02F 2201/05; G02F 2203/69

(57) ABSTRACT

An electro-optical element includes a substrate, and an optical functional layer formed on a main surface of the substrate, in which the optical functional layer includes an optical-input-side optical waveguide configured to guide light emitted from a light source, an optical branch part configured to branch the optical-input-side optical waveguide into two optical-modulation optical waveguides, a Mach-Zehnder optical modulation part configured to modulate light guided through the two optical-modulation optical waveguides, an optical coupling and branch part configured to branch the two optical-modulation optical waveguides configured to guide modulated light modulated by the Mach-Zehnder optical modulation part into one monitoring optical waveguide and a plurality of optical-output-side optical waveguides, and an optical coupling part configured to make the plurality of optical-output-side optical waveguides as one optical-output optical waveguide.

### BACKGROUND OF THE PRESENT INVENTION

### Field of the Present Invention

The present invention relates to an electro-optical element, a light source module, an optical engine, and XR glasses.

Priority is claimed on Japanese Patent Application No. 2023-110881 filed Jul. 5, 2023, the content of which is incorporated herein by reference.

### Description of Related Art

At present, in a technique such as virtual reality (VR) or augmented reality (AR), an eyeglasses-type terminal has been examined. In recent years, as the eyeglasses-type terminal, a retina scanning display that makes a user visually recognize an image by imaging light subjected to two-dimensional scanning on a retina of the user has been particularly attracting attention.

In general, in the retina scanning display, visible light beams of three colors emitted from a light source are coupled on one optical axis. The coupled visible light beam of the three colors is transmitted to an image display unit. The image display unit performs two-dimensional scanning with the transmitted light beam to input the light beam to a pupil of the user. The input light forms an image on the retina of the user, so that the user visually recognizes the image. In this case, the retina is a screen on which an image is displayed.

As XR glasses such as a retina scanning display, XR glasses that include a light source module including a light source and an electro-optical element to which light beams emitted from a light source are input are known. As the light source, a light emitting diode (LED), a laser diode (LD), or the like that emits light beams having wavelengths corresponding to respective colors of R (red), G (green), and B (blue) is used. As the electro-optical element, an electro-optical element including an optical waveguide made of lithium niobate (LiNbO₃) is known.

Patent Document 1 describes an optical modulator including a substrate having electro-optical effects, a first optical waveguide to which a first light beam is input, a second optical waveguide to which a second light beam having a wavelength longer than that of the first light beam is input, and a third optical waveguide to which a third light beam having a wavelength longer than that of the second light beam is input.

Patent Document 2 describes an optical waveguide element including a substrate having electro-optical effects, an optical waveguide formed on the substrate, and a photodetector that is disposed on the substrate and monitors a light wave propagating through the optical waveguide or a light wave radiated from the optical waveguide. In the optical waveguide element described in Patent Document 2, a monitoring optical waveguide that extends from the optical waveguide to the photodetector is provided.

### PATENT DOCUMENT

[Patent Document 1] Japanese Patent No. 6728596
[Patent Document 2] Japanese Unexamined Patent Application, First Publication No. 2021-162642

### SUMMARY OF THE INVENTION

An amount of light emitted from a light source such as a laser diode (LD) fluctuates depending on a temperature. For this reason, in a light source module including a light source such as an LD, and an electro-optical element to which light emitted from the light source is input, the intensity (amount) of output light emitted from the electro-optical element fluctuates depending on the temperature. In a case where the electro-optical element of the light source module includes an optical waveguide made of lithium niobate (LiNbO₃), a modulated waveform changes (DC drift) with the elapse of an application time of a direct-current (DC) voltage changing a refractive index of the optical waveguide.

For this reason, the light source module of the related art branches modulated light modulated by the electro-optical element into two as monitoring light and output light using a multimode interferometer (MMI) and detects a light intensity fluctuation and/or a DC drift amount of the monitoring light depending on the temperature with the photodetector. Then, feedback control for controlling the fluctuation of the modulated light emitted from the electro-optical element is performed by controlling a current that is supplied to the light source or controlling the direct-current (DC) voltage that changes the refractive index of the optical waveguide, according to a detection result of the monitoring light with a control unit.

Accordingly, in the light source module of the related art, to perform the feedback control, light having an intensity of ½ out of the modulated light emitted from the electro-optical element is used as the monitoring light. For this reason, in the light source module of the related art, a ratio of the output light to light input from the light source to the optical waveguide is low, and it is desirable to increase the ratio of the output light.

The present invention has been accomplished in view of the above-described problem, and an object of the present invention is to provide an electro-optical element capable of forming a light source module that achieves a high ratio of an intensity of output light to a light intensity input from a light source to an optical waveguide.

Another object of the present invention is to provide a light source module that is provided in the electro-optical element of the present invention and achieves a high ratio of an intensity of output light to a light intensity input from a light source to an optical waveguide.

Another object of the present invention is to provide an optical engine and XR glasses in which a light source module with a high ratio of an intensity of output light to a light intensity input from a light source to an optical waveguide is mounted.

An electro-optical element according to an aspect of the present invention includes a substrate, and an optical functional layer formed on a main surface of the substrate, in which the optical functional layer includes, an optical-input-side optical waveguide configured to guide light emitted from a light source, an optical branch part configured to branch the optical-input-side optical waveguide into two optical-modulation optical waveguides, a Mach-Zehnder optical modulation part configured to modulate light guided through the two optical-modulation optical waveguides, an optical coupling and branch part configured to branch the two optical-modulation optical waveguides configured to guide modulated light modulated by the Mach-Zehnder optical modulation part into one monitoring optical waveguide and a plurality of optical-output-side optical waveguides, and an optical coupling part configured to make the plurality of optical-output-side optical waveguides as one optical-output optical waveguide.

The electro-optical element of the present invention includes the optical functional layer including the optical coupling and branch part configured to the two optical-modulation optical waveguides configured to guide the modulated light modulated by the Mach-Zehnder optical modulation part into one monitoring optical waveguide and the plurality of optical-output-side optical waveguides and the optical coupling part configured to make the plurality of optical-output-side optical waveguides as one optical-output optical waveguide. Accordingly, in the electro-optical element of the present invention, only a light intensity of 1/(the number of optical-output-side optical waveguides+1) out of the modulated light emitted from the electro-optical element is used as the monitoring light. Therefore, a light source module including the electro-optical element of the present invention and a light source achieves a small amount of light being used as monitoring light and a high ratio of an intensity of output light to a light intensity input from the light source to the optical waveguide.

The light source module of the present invention includes the electro-optical element of the present invention and the light source. The optical engine and the XR glasses of the present invention include the light source module of the present invention mounted therein. Accordingly, the light source module, the optical engine, and the XR glasses of the present invention can efficiently use light emitted from the light source.

### BRIEF DESCRIPTION OF THE DRAWINGS

FIG. 1 is a schematic plan view illustrating an electro-optical element according to a first embodiment.

FIG. 2 is a schematic cross-sectional view of the electro-optical element illustrated in FIG. 1 taken along line X-X′.

FIG. 3 is a schematic plan view illustrating an electro-optical element according to a second embodiment.

FIG. 4 is a schematic plan view illustrating an electro-optical element according to a third embodiment.

FIG. 5 is a schematic plan view illustrating a light source module according to a fourth embodiment including an electro-optical element 100 according to the first embodiment illustrated in FIG. 1.

FIG. 6 is a schematic plan view illustrating a light source module according to a fifth embodiment including an electro-optical element 200 according to the second embodiment illustrated in FIG. 3.

FIG. 7 is a schematic plan view illustrating a light source module according to a sixth embodiment including an electro-optical element 300 according to the third embodiment illustrated in FIG. 4.

FIG. 8 is a conceptual diagram illustrating an example of XR glasses of the present invention.

FIG. 9 is a conceptual diagram illustrating a manner in which an image is directly projected on a retina by light emitted from a light source module in the XR glasses illustrated in FIG. 8.

FIG. 10A is a plan view of an optical coupling and branch part 52 subjected to a simulation of Example 1 and optical waveguides connected thereto.

FIG. 10B is a cross-sectional view taken along line A-A′ of FIG. 10A.

FIG. 10C is a cross-sectional view taken along line B-B′ of FIG. 10A.

### DETAILED DESCRIPTION OF THE INVENTION

To solve the above-described problem and to provide an electro-optical element capable of forming a light source module that achieves a high ratio of an intensity of output light to a light intensity input from a light source to an optical waveguide, the present inventors have conducted intense studies focusing on an optical coupling and branch part configured to branch an optical-modulation optical waveguide configured to guide modulated light modulated by a Mach-Zehnder optical modulation part into a monitoring optical waveguide.

As a result, the present inventors have found that, in an optical coupling and branch part of an electro-optical element, two optical-modulation optical waveguides configured to guide modulated light modulated by a Mach-Zehnder optical modulation part may be branched into three or more optical waveguides, only one optical waveguide may be made as a monitoring optical waveguide, and other optical waveguides may be made as optical-output-side optical waveguides, and have conceived the present invention.

In the electro-optical element including such an optical coupling and branch part, only a light intensity of 1/(the number of optical-output-side optical waveguides+1) out of modulated light emitted from the electro-optical element is used as monitoring light. For this reason, an amount of light being used as monitoring light is small, a ratio of an intensity of output light to a light intensity input from the light source to the optical waveguide is high, and light emitted from the light source can be efficiently used.

The present invention includes the following aspects.

[1] An electro-optical element including
a substrate, and
an optical functional layer formed on a main surface of the substrate,
in which the optical functional layer includes,
   an optical-input-side optical waveguide configured to guide light emitted from a light source,
   an optical branch part configured to branch the optical-input-side optical waveguide into two optical-modulation optical waveguides,
   a Mach-Zehnder optical modulation part configured to modulate light guided through the two optical-modulation optical waveguides,
   an optical coupling and branch part configured to branch the two optical-modulation optical waveguides configured to guide modulated light modulated by the Mach-Zehnder optical modulation part into one monitoring optical waveguide and a plurality of optical-output-side optical waveguides, and
   an optical coupling part configured to make the plurality of optical-output-side optical waveguides as one optical-output optical waveguide.

[2] The electro-optical element according to [1],
in which all of the optical-input-side optical waveguide, the optical-modulation optical waveguides, the monitoring optical waveguide, the optical-output-side optical waveguides, and the optical-output optical waveguide are made of lithium niobate.

[3] The electro-optical element according to [1],
in which all of the optical branch part, the optical coupling and branch part, and the optical coupling part are multimode interferometers.

[4] The electro-optical element according to [1],
in which a number of the plurality of optical-output-side optical waveguides is two.

[5] The electro-optical element according to [1], further including
a photodetector configured to detect a light intensity fluctuation of monitoring light guided through the monitoring optical waveguide, and
a control unit configured to correct an intensity of light guided through the optical-modulation optical waveguides according to a detection result of the monitoring light in the photodetector.

[6] The electro-optical element according to [1],
in which the optical functional layer further includes a light input port through which the light emitted from the light source is input to the optical-input-side optical waveguide, and
the optical-input-side optical waveguide guides the light input from the light input port.

[7] The electro-optical element according to [5],
in which the optical functional layer further includes bias electrodes provided on the two optical-modulation optical waveguides disposed between the optical branch part and the Mach-Zehnder optical modulation part, respectively, and
a DC voltage that is applied from the bias electrodes to the optical-modulation optical waveguides is controlled by the control unit.

[8] The electro-optical element according to [1],
in which the optical functional layer includes,
   three optical modulation parts each including the optical-input-side optical waveguide,
   the optical branch part,
   the Mach-Zehnder optical modulation part,
   the optical coupling and branch part, and
   the optical coupling part, and
the optical-input-side optical waveguides of the respective optical modulation parts guide light having different wavelengths.

[9] A light source module including
a light source, and
the electro-optical element according to any one of [1] to [8].

[10] A light source module including
a light source, and
the electro-optical element according to [5],
in which a current that is supplied to the light source is controlled by the control unit.

[11] The optical engine in which the light source module according to [9] is mounted.

[12] XR glasses in which the light source module according to [9] is mounted.

Hereinafter, an electro-optical element, a light source module, an optical engine, and XR glasses of the present embodiment will be described in detail with reference to the drawings as appropriate. In the drawings used in the following description, characteristic portions may be enlarged for convenience to make the features of the present invention easy to understand. Accordingly, the dimensional ratios or the like of respective components are different from the actual ones. Materials, dimensions, and the like illustrated in the following description are examples, and the present invention is not limited thereto, and can be changed and implemented as appropriate within a range in which the effects of the present invention can be obtained.

### Electro-Optical Element

### First Embodiment

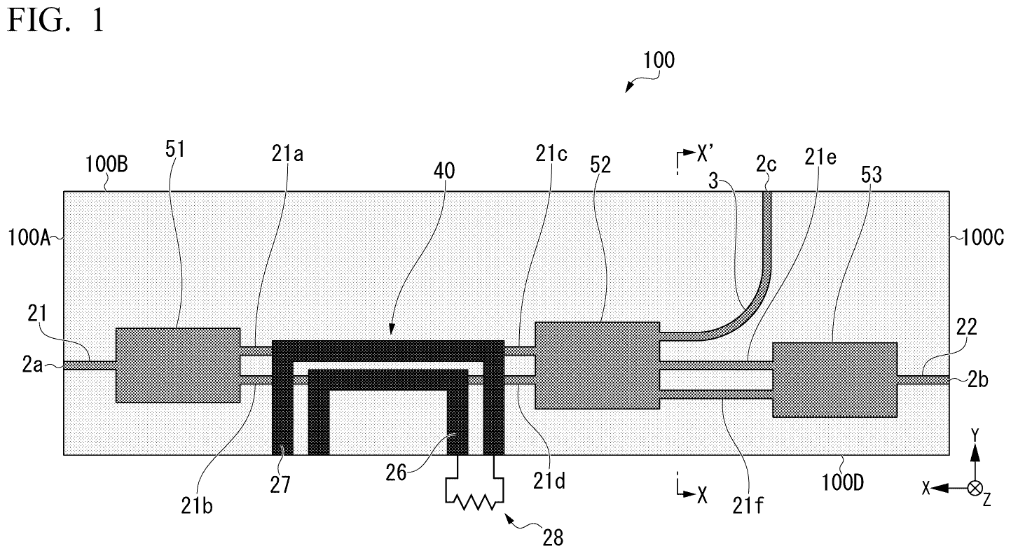

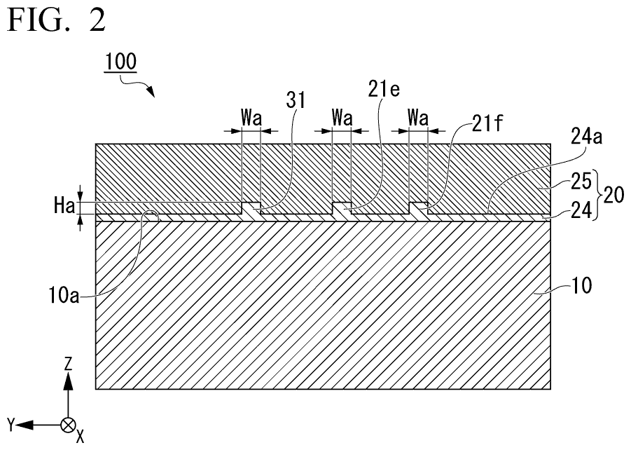

FIG. 1 is a schematic plan view illustrating an electro-optical element according to a first embodiment. FIG. 2 is a schematic cross-sectional view of the electro-optical element illustrated in FIG. 1 taken along line X-X′.

As illustrated in FIG. 2, an electro-optical element 100 illustrated in FIG. 1 includes a substrate 10 and an optical functional layer 20 formed on a main surface 10a of the substrate 10. As illustrated in FIG. 2, the optical functional layer 20 is made of an optical waveguide core film 24 and an optical waveguide cladding (buffer) film 25 formed on the optical waveguide core film 24 to cover the optical waveguide core film 24.

As illustrated in FIG. 1, the optical functional layer 20 includes a light input port 2a, an optical-input-side optical waveguide 21, an optical branch part 51, optical-modulation optical waveguides 21a, 21b, 21c, and 21d, a Mach-Zehnder optical modulation part 40, an optical coupling and branch part 52, a monitoring optical waveguide 3, a monitoring light output port 2c, optical-output-side optical waveguides 21e and 21f, an optical coupling part 53, an optical-output optical waveguide 22, and a light output port 2b.

The electro-optical element 100 of the present embodiment has a substantially rectangular shape in a plan view, and as illustrated in FIG. 1, has four side surfaces including a first side surface 100A and a third side surface 100C along a short side of the rectangle and a second side surface 100B and a fourth side surface 100D along a long side of the rectangle. In the electro-optical element 100 of the present embodiment, the light input port 2a is provided in the first side surface 100A, and the light output port 2b is provided in the third side surface 100C. In the electro-optical element 100 of the present embodiment, the monitoring light output port 2c is provided in the second side surface 100B.

In the electro-optical element 100 of the present embodiment, positions where the light input port 2a, the light output port 2b, and the monitoring light output port 2c are provided are not limited to the positions illustrated in FIG. 1, respectively. For example, in the present embodiment, although a case where the monitoring light output port 2c is provided in the second side surface 100B has been described as an example, the monitoring light output port 2c may be provided in any of the first side surface 100A, the third side surface 100C, and the fourth side surface 100D, and the position where the monitoring light output port 2c is provided is not particularly limited. In a case where the monitoring light output port 2c is provided in the fourth side surface 100D, the monitoring optical waveguide 3 may intersect other optical guides, for example, the optical-output-side optical waveguides 21e and 21f, in a plan view.

Each of the light input port 2a, the light output port 2b, and the monitoring light output port 2c may allow input and output in an upper surface of the electro-optical element 100 using a structure of a grating coupler, a mirror, or the like. In this case, the light input port 2a, the light output port 2b, and the monitoring light output port 2c do not need to be provided in the first side surface 100A, the third side surface 100C, and the fourth side surface 100D, and may be provided at any places in the upper surface of the electro-optical element 100.

In the present embodiment, although the electro-optical element 100 having a substantially rectangular shape in a plan view has been described as an example, the planar shape of the electro-optical element 100 is not limited to a substantially rectangular shape. The planar shape of the electro-optical element 100 can be determined according to the purpose or the like of the electro-optical element 100 as appropriate, and may be any planar shape.

The light input port 2a allows light emitted from a light source to be input to the optical-input-side optical waveguide 21 and is provided in the first side surface 100A.

The optical-input-side optical waveguide 21 guides light emitted from the light source and input from the light input port 2a.

The optical branch part 51 branches one optical-input-side optical waveguide 21 into two optical-modulation optical waveguides 21a and 21b. As the optical branch part 51, a known optical branch part can be used, and a multimode interferometer (MMI) is preferably used.

The Mach-Zehnder optical modulation part 40 modulates light guided through the two optical-modulation optical waveguides 21a and 21b. As the Mach-Zehnder optical modulation part 40, a Mach-Zehnder optical modulation part having a known configuration can be used. As illustrated in FIG. 1, in the Mach-Zehnder optical modulation part 40, electrodes 26 and 27 that apply a modulation voltage to the Mach-Zehnder optical modulation part 40 are provided. One end of the electrode 26 is connected to a power supply (not illustrated), and the other end of the electrode 26 is connected to a termination resistor 28. One end of the electrode 27 is connected to the power supply (not illustrated), and the other end of the electrode 27 is connected to the termination resistor 28. As the electrodes 26 and 27, for example, electrodes made of an Au film or electrodes made of a laminated film of a Ti film and an Au film can be used.

The optical coupling and branch part 52 couples two optical-modulation optical waveguides 21c and 21d that guide modulated light modulated by the Mach-Zehnder optical modulation part 40, and branches the coupled optical waveguide into one monitoring optical waveguide 3 and a plurality of optical-output-side optical waveguides 21e and 21f. If the number of optical-output-side optical waveguides 21e and 21f is two, it is preferable since the length of the optical coupling part 53 can be reduced.

In the present embodiment, although a case where the number of optical-output-side optical waveguides 21e and 21f is two is described as an example, the number of optical-output-side optical waveguides may be plural or may be three or more. In a case where the number of optical-output-side optical waveguides is three or more, an amount of light being used as monitoring light out of modulated light emitted from the electro-optical element 100 can be further reduced.

As the optical coupling and branch part 52, a known optical coupling and branch part can be used, and a multimode interferometer (MMI) is preferably used.

The optical coupling part 53 couples a plurality of (in the present embodiment, two) optical-output-side optical waveguides 21e and 21f as one optical-output optical waveguide 22. As the optical coupling part 53, a known optical coupling part can be used, and a multimode interferometer (MMI) is preferably used.

In the present embodiment, at least one selected from the optical branch part 51, the optical coupling and branch part 52, and the optical coupling part 53 is preferably a multimode interferometer. Most preferably, all the optical branch part 51, the optical coupling and branch part 52, and the optical coupling part 53 are multimode interferometers. A multimode interferometer (MMI) can prevent an increase in coupling length compared to a case where a directional coupler is provided instead of a multimode interferometer, for example. Accordingly, in a case where at least one selected from the optical branch part 51, the optical coupling and branch part 52, and the optical coupling part 53 is a multimode interferometer, it is possible to achieve both improvement of a degree of freedom and reduction in size in the design of the electro-optical element 100. At least one selected from the optical branch part 51, the optical coupling and branch part 52, and the optical coupling part 53 is a multimode interferometer, so that loss of light due to variation during manufacturing of the electro-optical element 100 is made small.

The electro-optical element 100 of the present embodiment preferably includes a photodetector (not illustrated) that detects a light intensity fluctuation of monitoring light guided through the monitoring optical waveguide 3, and a control unit (not illustrated) that corrects an intensity of light guided through the optical-modulation optical waveguides 21a, 21b, 21c, and 21d according to a detection result of the monitoring light in the photodetector.

As the photodetector, for example, a known photodiode can be used.

The control unit corrects the intensity of light guided through the optical-modulation optical waveguides 21a, 21b, 21c, and 21d according to the detection result of the monitoring light in the photodetector, and for example, controls a current that is supplied to the light source (not illustrated), according to the detection result of the monitoring light and/or controls a direct-current (DC) voltage that is supplied to the electrodes 26 and 27 configured to supply a modulation voltage to the Mach-Zehnder optical modulation part 40.

In the present embodiment, all the optical-input-side optical waveguide 21, the optical-modulation optical waveguides 21a, 21b, 21c, and 21d, the monitoring optical waveguide 3, the optical-output-side optical waveguides 21e and 21f, and the optical-output optical waveguide 22 illustrated in FIG. 1 are optical waveguides made of the optical waveguide core film 24 illustrated in FIG. 2. All the optical waveguides preferably have a ridge-like shape (protrusion-like shape) protruding from a first surface 24a of the optical waveguide core film 24 (see cross-sectional shapes of the monitoring optical waveguide 3 and the optical-output-side optical waveguides 21e and 21f in FIG. 2). As illustrated in FIG. 2, the first surface 24a of the optical waveguide core film 24 is an upper surface of the optical waveguide core film 24 in a non-ridge-like portion (slab portion).

The cross-sectional shapes of the optical-input-side optical waveguide 21, the optical-modulation optical waveguides 21a, 21b, 21c, and 21d, the monitoring optical waveguide 3, the optical-output-side optical waveguides 21e and 21f, and the optical-output optical waveguide 22 illustrated in FIG. 1 may be a shape capable of guiding light. The cross-sectional shape is preferably a ridge-like shape, and can be, for example, a shape such as a substantially rectangular shape, a substantially trapezoidal shape, a substantially triangular shape, or a substantially semicircular shape.

In a case where the cross-sectional shape of the optical waveguide (the optical-input-side optical waveguide 21, the optical-modulation optical waveguides 21a, 21b, 21c, and 21d, the monitoring optical waveguide 3, the optical-output-side optical waveguides 21e and 21f, and the optical-output optical waveguide 22) in the electro-optical element 100 of the present embodiment is a ridge-like shape, a width (in FIG. 2, Wa) of the cross-sectional shape of the optical waveguide in a width direction (y direction) of the electro-optical element 100 can be set, for example, to be equal to or greater than 0.2 μm and equal to or less than 5.0 μm, and a height (in FIG. 2, a protrusion height Ha from the first surface 24a) of the cross-sectional shape of the optical waveguide can be set, for example, to be equal to or greater than 0.1 μm and equal to or less than 1.0 μm.

A film thickness of the optical waveguide core film 24 in the electro-optical element 100 of the present embodiment can be set, for example, to be equal to or greater than 0.5 μm and equal to or less than 2 μm. The film thickness of the optical waveguide core film 24 is a film thickness of a portion (slab portion) having no ridge-like shape of the optical waveguide core film 24. The film thickness of the optical waveguide core film 24 can be determined according to a wavelength of light guided through the optical waveguide, the cross-sectional shape of the optical waveguide in the electro-optical element 100, and the like as appropriate.

In the electro-optical element 100 illustrated in FIG. 1, as the substrate 10 illustrated in FIG. 2, a known substrate can be used, and can be determined according to the material of the optical functional layer 20 as appropriate. In a case where the optical waveguide core film 24 of the optical functional layer 20 that is formed in contact with the main surface 10a of the substrate 10 and that forms the optical waveguide is an epitaxial film made of a lithium niobate (LiNbO₃) film, as the substrate 10, a known single-crystal substrate in which an epitaxial film made of a lithium niobate (LiNbO₃) film can be grown is used. The substrate 10 in this case preferably has a refractive index lower than lithium niobate, and for example, a sapphire single-crystal substrate or a silicon single-crystal substrate can be used.

In the electro-optical element 100 of the present embodiment, as the substrate 10, a sapphire single-crystal substrate is particularly preferably used, and the sapphire single-crystal substrate has a refractive index lower than a lithium niobate (LiNbO₃) film. For this reason, in a case where the optical waveguide core film 24 is an epitaxial film made of a lithium niobate film, in the optical waveguide made of the optical waveguide core film 24, the substrate 10 can serve as a cladding layer. Accordingly, in a case where the substrate 10 is a sapphire single-crystal substrate, and the optical waveguide core film 24 is an epitaxial film made of a lithium niobate film, the optical waveguide core film 24 can be suitably used as an optical waveguide without separately providing a cladding layer between the substrate 10 and the optical waveguide core film 24.

The epitaxial film made of the lithium niobate (LiNbO₃) film is easily formed as a c-axis-oriented epitaxial film with respect to a single-crystal substrate of various crystal orientations. For this reason, in the electro-optical element 100 of the present embodiment, in a case where the optical waveguide core film 24 is made of the lithium niobate film which is the c-axis-oriented epitaxial film, the crystal orientation of the substrate 10 is not particularly limited.

In a case where the optical waveguide core film 24 is made of the lithium niobate film which is the c-axis-oriented epitaxial film, the optical waveguide core film 24 has three-fold symmetry. Accordingly, it is desirable that the crystal orientation of the main surface 10a of the substrate 10 has the same symmetry as the optical waveguide core film 24. For this reason, for example, in a case where a sapphire single-crystal substrate is used as the substrate 10, the main surface 10a is preferably a c-plane. For example, in a case where a silicon single-crystal substrate is used as the substrate 10, the main surface 10a is preferably a (111) plane.

As the optical waveguide core film 24, a known optical waveguide core film can be used. As the optical waveguide core film 24, the lithium niobate film which is the c-axis-oriented epitaxial film is preferably used. The lithium niobate film forming the optical waveguide core film 24 contains lithium niobate (LiNbO₃) as a main component. Since lithium niobate has a large electro-optical constant, lithium niobate is suitably used as the material of the optical waveguide.

A composition of the lithium niobate film that forms the optical waveguide core film 24 is represented by, for example, a general formula LixNbAyOz (In the formula, A is an element other than Li, Nb, and O. x is 0.5 to 1.2, y is 0 to 0.5, and z is 1.5 to 4.).

In the formula, A represents an element other than Li, Nb, and O. Examples of the element represented by A include K, Na, Rb, Cs, Be, Mg, Ca, Sr, Ba, Ti, Zr, Hf, V, Cr, Mo, W, Fe, Co, Ni, Zn, Sc, and Ce. The element represented by A may be only one kind or may be two kinds or more.

In the formula, x is 0.5 to 1.2, and preferably, is 0.9 to 1.05.

In the formula, y is 0 to 0.5.

In the formula, z is 1.5 to 4, and preferably, is 2.5 to 3.5.

In a case where the optical waveguide core film 24 is made of the lithium niobate film which is the c-axis-oriented epitaxial film, and the substrate 10 is made of a single-crystal substrate, the crystal orientation of the lithium niobate film forming the optical waveguide core film 24 is oriented in alignment with the crystal orientation of the underlying substrate 10. In more detail, when a film plane of the lithium niobate film forming the optical waveguide core film 24 is defined as an X-Y plane, and a film thickness direction is defined as a Z axis, a crystal of the single-crystal substrate forming the substrate 10 and a crystal of the epitaxial film forming the optical waveguide core film 24 are aligned and oriented in X-axis, Y-axis, and Z-axis directions.

The optical waveguide core film 24 being the c-axis-oriented epitaxial film can be verified by first confirming a peak intensity at an orientation position by 2θ-θ X-ray diffraction and secondly confirming a pole by pole measurement, for example.

Specifically, in verifying that the optical waveguide core film 24 is the c-axis-oriented epitaxial film, as a first condition, when measurement is performed by 2θ-θ X-ray diffraction, a peak intensity of all peaks other than a target surface needs to be equal to or less 10% and preferably, equal to or less than 5%, of a maximum peak intensity of the target surface. In the c-axis-oriented epitaxial film forming the optical waveguide core film 24, a peak intensity of planes other than a (00L) plane is equal to or less than 10%, and preferably, equal to or less than 5%, of a maximum peak intensity of the (00L) plane. (00L) is a generic term for equivalent planes such as (001) and (002).

Under the above-described condition of confirming the peak intensity at the orientation position by 2θ-θ X-ray diffraction, only orientation in a single direction is shown. Accordingly, even if the above-described first condition is satisfied, in a case where the in-plane crystal orientation is not aligned, an intensity of X-rays is not increased at a specific angle position, and no pole is observed.

Accordingly, in verifying that the optical waveguide core film 24 is the c-axis-oriented epitaxial film, as a second condition, a pole needs to be observed in the pole measurement.

Since LiNbO₃ has a trigonal crystal structure, single-crystal LiNbO₃ (014) has three poles. In a case where the lithium niobate film is epitaxially grown, it is known that the lithium niobate film is epitaxially grown in a so-called twin crystal state in which crystals rotated by 180° about the c-axis are symmetrically coupled. In this case, since two of three poles are symmetrically coupled, there are six poles.

In the electro-optical element 100 of the present embodiment, for the c-axis of the lithium niobate film forming the optical waveguide core film 24, for example, in a case where a sapphire single-crystal substrate with the c-plane as the main surface 10a is used as the substrate 10, the c-axis of the optical waveguide core film 24 and the c-axis of the substrate 10 preferably have a deviation equal to or less than 5°, and more preferably, coincide with other (0°). If the deviation between the c-axis of the optical waveguide core film 24 and the c-axis of the substrate 10 is equal to or less than 5°, no practical problem occurs in the characteristics of the electro-optical element 100 due to the deviation between the c-axis of the optical waveguide core film 24 and the c-axis of the substrate 10.

In the electro-optical element 100 of the present embodiment, as the optical waveguide cladding (buffer) film 25 formed on the optical waveguide core film 24, a known optical waveguide cladding (buffer) film can be used. As the cladding (buffer) film 25, for example, a SiO₂ film can be used.

The electro-optical element 100 of the present embodiment includes the optical functional layer 20 including the optical coupling and branch part 52 configured to branch the two optical-modulation optical waveguides 21c and 21d configured to guide the modulated light modulated by the Mach-Zehnder optical modulation part 40 into one monitoring optical waveguide 3 and the two optical-output-side optical waveguides 21e and 21f and the optical coupling part 53 configured to make the two optical-output-side optical waveguides 21e and 21f as one optical-output optical waveguide 22. Accordingly, in the electro-optical element 100 of the present embodiment, only the light intensity of 1/(the number of optical-output-side optical waveguides 21e and 21f (two)+1) out of the modulated light emitted from the electro-optical element 100 is used as the monitoring light. Therefore, the electro-optical element 100 of the present embodiment can form a light source module that achieves a small amount of light being used as the monitoring light out of the modulated light emitted from the electro-optical element 100 and a high ratio of an intensity of output light to a light intensity input from the light source to the optical waveguide.

Besides, the electro-optical element 100 of the present embodiment includes the photodetector (not illustrated) configured to detect the light intensity fluctuation of the monitoring light guided through the monitoring optical waveguide 3, and the control unit (not illustrated) configured to correct the intensity of light guided through the optical-modulation optical waveguides 21a, 21b, 21c, and 21d according to the detection result of the monitoring light in the photodetector. In the electro-optical element 100 of the present embodiment, for example, the feedback control for controlling the current that is supplied to the light source (not illustrated) and/or controlling the direct-current (DC) voltage that is supplied to the electrodes 26 and 27 configured to apply the modulation voltage to the Mach-Zehnder optical modulation part 40, according to the detection result of the monitoring light in the photodetector, can be performed with the control unit. Accordingly, with the electro-optical element 100 of the present embodiment, stable modulated light with suppressed fluctuation due to the temperature and/or the DC drift amount can be emitted.

### Second Embodiment

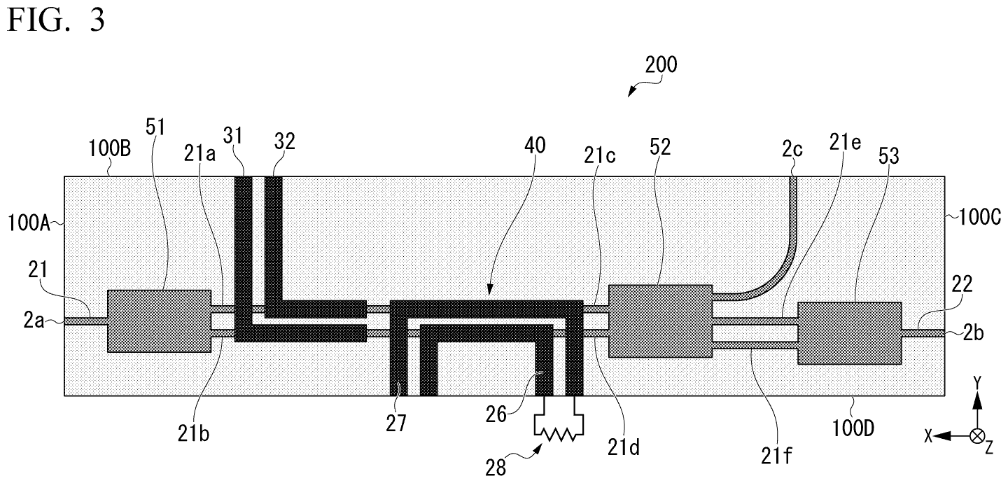

FIG. 3 is a schematic plan view illustrating an electro-optical element according to a second embodiment. In an electro-optical element 200 according to the second embodiment illustrated in FIG. 3, members common to the electro-optical element 100 according to the first embodiment illustrated in FIGS. 1 and 2 are represented by the same reference signs, and description thereof may not be repeated.

The electro-optical element 200 according to the second embodiment illustrated in FIG. 3 is different from the electro-optical element 100 according to the first embodiment illustrated in FIGS. 1 and 2 in that direct-current (DC) bias electrodes 31 and 32 are provided on the two optical-modulation optical waveguides 21a and 21b disposed between the optical branch part 51 and the Mach-Zehnder optical modulation part 40, respectively, and the DC voltage that is applied from the bias electrodes 31 and 32 to the optical-modulation optical waveguides 21a and 21b is controlled with the control unit. As the bias electrodes 31 and 32, for example, electrodes made of an Au film or electrodes made of a laminated film of a Ti film and an Au film can be used.

The control unit corrects the intensity of light guided through the optical-modulation optical waveguides 21a, 21b, 21c, and 21d according to the detection result of the monitoring light in the photodetector (not illustrated) configured to detect the light intensity fluctuation of the monitoring light guided through the monitoring optical waveguide 3, and controls the DC voltage that is applied from the bias electrodes 31 and 32 to the optical-modulation optical waveguides 21a and 21b. The control unit may control the current that is supplied to the light source (not illustrated) and/or control the direct-current (DC) voltage that is supplied to the electrodes 26 and 27 configured to apply the modulation voltage to the Mach-Zehnder optical modulation part 40, and may control the DC voltage that is applied from the direct-current (DC) bias electrodes 31 and 32 to the optical-modulation optical waveguides 21a and 21b.

Also in the electro-optical element 200 according to the second embodiment illustrated in FIG. 3, as in the electro-optical element 100 according to the first embodiment illustrated in FIGS. 1 and 2, only the light intensity of 1/(the number of optical-output-side optical waveguides 21e and 21f (two)+1) out of the modulated light emitted from the electro-optical element 200 is used as the monitoring light. Therefore, the electro-optical element 200 according to the second embodiment can also form a light source module that achieves a small amount of light being used as a monitoring light out of the modulated light emitted from the electro-optical element 200 and a high ratio of an intensity of output light to a light intensity input from the light source to the optical waveguide.

The electro-optical element 200 according to the second embodiment illustrated in FIG. 3 includes the photodetector (not illustrated) configured to the light intensity fluctuation of the monitoring light guided through the monitoring optical waveguide 3, and the control unit (not illustrated) configured to correct the intensity of light guided through the optical-modulation optical waveguides 21a, 21b, 21c, and 21d according to the detection result of the monitoring light in the photodetector, and the direct-current (DC) bias electrodes 31 and 32 are provided on the two optical-modulation optical waveguides 21a and 21b disposed between the optical branch part 51 and the Mach-Zehnder optical modulation part 40, respectively.

For this reason, in the electro-optical element 200 illustrated in FIG. 3, the feedback control for controlling the DC voltage that is applied from the direct-current (DC) bias electrodes 31 and 32 to the optical-modulation optical waveguides 21a and 21b, according to the detection result of the monitoring light in the photodetector, can be performed with the control unit. Accordingly, with the electro-optical element 200 of the present embodiment, light guided through the optical-modulation optical waveguides 21a and 21b before reaching the Mach-Zehnder optical modulation part 40 is modulated, so that stable modulated light with suppressed fluctuation due to the temperature and/or the DC drift amount can be emitted.

In the electro-optical element 200 illustrated in FIG. 3, the feedback control for controlling the current that is supplied to the light source (not illustrated) and/or controlling the direct-current (DC) voltage that is supplied to the electrodes 26 and 27 configured to apply the modulation voltage to the Mach-Zehnder optical modulation part 40, and controlling the DC voltage that is applied from the direct-current (DC) bias electrodes 31 and 32 to the optical-modulation optical waveguides 21a and 21b can be performed with the control unit. With this, stable modulated light in which the fluctuation due to the temperature and/or the DC drift amount is more effectively suppressed can be emitted from the electro-optical element 200 of the present embodiment.

### Third Embodiment

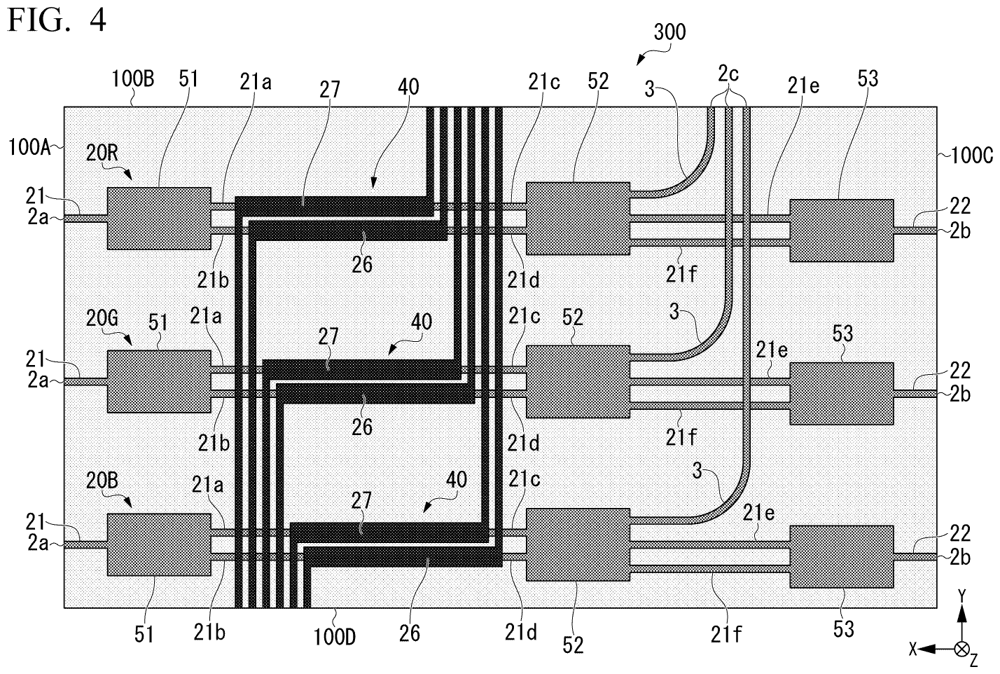

FIG. 4 is a schematic plan view illustrating an electro-optical element according to a third embodiment. In an electro-optical element 300 according to the third embodiment illustrated in FIG. 4, members common to the electro-optical element 100 according to the first embodiment illustrated in FIGS. 1 and 2 are represented by the same reference signs, and description thereof may not be repeated.

The electro-optical element 300 according to the third embodiment illustrated in FIG. 3 is different from the electro-optical element 100 according to the first embodiment illustrated in FIGS. 1 and 2 in that an optical functional layer 20 has three optical modulation parts 20R, 20G, and 20B.

Each of the optical modulation parts 20R, 20G, and 20B in the electro-optical element 300 according to the third embodiment includes the light input port 2a, the optical-input-side optical waveguide 21, the optical branch part 51, the optical-modulation optical waveguides 21a, 21b, 21c, and 21d, the Mach-Zehnder optical modulation part 40, the optical coupling and branch part 52, the monitoring optical waveguide 3, the monitoring light output port 2c, the optical-output-side optical waveguides 21e and 21f, the optical coupling part 53, the optical-output optical waveguide 22, and the light output port 2b.

The optical-input-side optical waveguides 21 of the optical modulation parts 20R, 20G, and 20B guide light having different wavelengths emitted from the light source and input from the light input port 2a.

Specifically, the optical-input-side optical waveguide 21 of the optical modulation part 20R guides red light having a peak wavelength equal to or greater than 610 nm and equal to or less than 750 nm, for example. The optical-input-side optical waveguide 21 of the optical modulation part 20G guides green light having a peak wavelength equal to or greater than 500 nm and equal to or less than 560 nm, for example. The optical-input-side optical waveguide 21 of the optical modulation part 20B guides blue light having a peak wavelength equal to or greater than 435 nm and equal to or less than 480 nm.

In a case where the optical-input-side optical waveguides 21 of the optical modulation parts 20R, 20G, and 20B in the electro-optical element 300 according to the third embodiment guide red light, green light, and blue light, respectively, the electro-optical element 300 can be suitably used for, for example, XR glasses capable of displaying a full-color image.

In each of the optical modulation parts 20R, 20G, and 20B of the electro-optical element 300 of the present embodiment, the positions where the light input port 2a, the light output port 2b, and the monitoring light output port 2c are provided are not limited to the positions illustrated in FIG. 4, respectively. For example, in the present embodiment, although a case where the monitoring light output port 2c is provided in the second side surface 100B in all the optical modulation parts 20R, 20G, and 20B has been described as an example, the monitoring light output port 2c in each of the optical modulation parts 20R, 20G, and 20B may be provided in any of the first side surface 100A, the third side surface 100C, and the fourth side surface 100D, and the position where the monitoring light output port 2c is provided is not particularly limited. For example, only the monitoring light output port 2c in the optical modulation part 20G or only the monitoring light output port 2c in the optical modulation part 20B may be provided in the third side surface 100C or the fourth side surface 100D.

The light input port 2a, the light output port 2b, and the monitoring light output port 2c may allow input and output in an upper surface of the electro-optical element 300 using a structure of a grating coupler, a mirror, or the like. In this case, the light input port 2a, the light output port 2b, and the monitoring light output port 2c do not need to be provided in the first side surface 100A, the third side surface 100C, and the fourth side surface 100D, and may be provided at any places in the upper surface of the electro-optical element 300.

The monitoring optical waveguide 3 of each of the optical modulation parts 20R, 20G, and 20B of the electro-optical element 300 may intersect the optical waveguides of other optical modulation parts in a plan view (for example, see the monitoring optical waveguides 3 of the optical modulation parts 20G and 20B in FIG. 4).

In each of the optical modulation parts 20R, 20G, and 20B of the electro-optical element 300 of the present embodiment, the electrodes 26 and 27 configured to apply the modulation voltage to the Mach-Zehnder optical modulation part 40 have one end connected to the power supply (not illustrated) and the other end connected to the termination resistor (not illustrated).

In each of the optical modulation parts 20R, 20G, and 20B in the electro-optical element 300 according to the third embodiment illustrated in FIG. 4, as in the electro-optical element 100 according to the first embodiment illustrated in FIGS. 1 and 2, only the light intensity of 1/(the number of optical-output-side optical waveguides 21e and 21f (two)+1) out of the modulated light emitted from each of the optical modulation parts 20R, 20G, and 20B is used as monitoring light. Therefore, each of the optical modulation parts 20R, 20G, and 20B in the electro-optical element 300 according to the third embodiment achieves a small amount of light being used as monitoring light out of the modulated light emitted from each of the optical modulation parts 20R, 20G, and 20B and a high ratio of an intensity of output light to a light intensity input from the light source to the optical waveguide.

### Other Examples

The electro-optical element of the present invention is not limited to the electro-optical elements of the first embodiment to the third embodiment described above, and can be changed and implemented as appropriate within a range that does not deviate from the gist of the present invention.

For example, as in the electro-optical element 200 according to the second embodiment illustrated in FIG. 3, each of the optical modulation parts 20R, 20G, and 20B in the electro-optical element 300 according to the third embodiment illustrated in FIG. 4 includes direct-current (DC) bias electrodes 31 32 that are provided on the two optical-modulation optical waveguides 21a and 21b disposed between the optical branch part 51 and the Mach-Zehnder optical modulation part 40, respectively, and the DC voltage that is applied from the bias electrodes 31 and 32 to the optical-modulation optical waveguides 21a and 21b may be controlled with the control unit.

### Light Source Module

### Fourth Embodiment

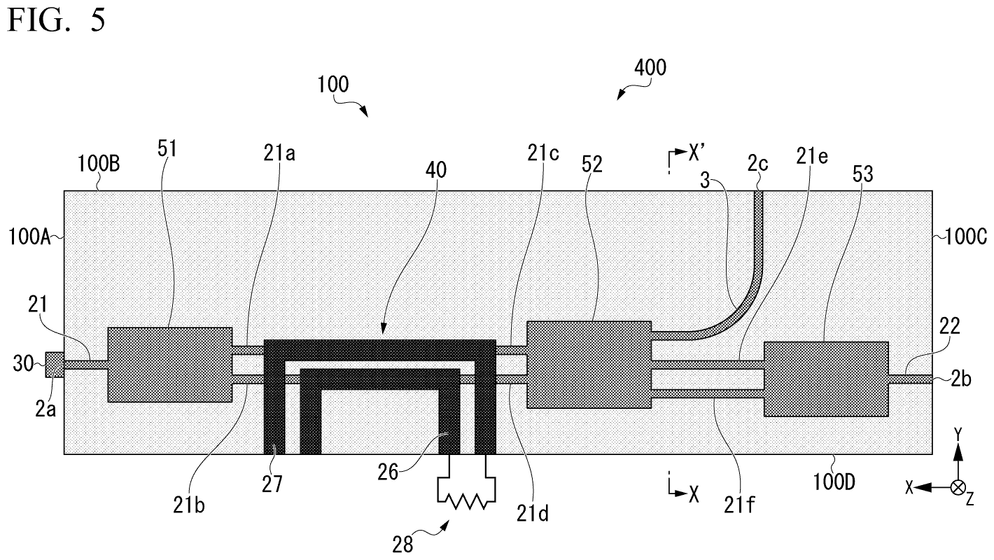

FIG. 5 is a schematic plan view illustrating a light source module according to a fourth embodiment including the electro-optical element 100 according to the first embodiment illustrated in FIG. 1. A light source module 400 of the present embodiment includes the electro-optical element 100 of the first embodiment and a light source 30.

As illustrated in FIG. 5, the light source 30 emits light that is input from the light input port 2a of the electro-optical element 100 and is guided through the optical-input-side optical waveguide 21. As the light source 30, a laser element such as a laser diode (LD) can be used, and various commercially available laser elements that emit a light having a specific wavelength such as red light, green light, or blue light can be used.

In the light source module 400 of the present embodiment, a current that is supplied to the light source 30 is preferably controlled according to the detection result of the light intensity fluctuation of the monitoring light guided through the monitoring optical waveguide 3 of the electro-optical element 100 with the control unit of the electro-optical element 100. In this case, with the control of the current that is supplied to the light source 30, the amount of light that is emitted from the light source 30 can be adjusted, and even if the modulated light fluctuates depending on the temperature and/or the DC drift amount, the intensity (amount) of light that is guided through the optical-modulation optical waveguides 21a, 21b, 21c, and 21d can be corrected according to the fluctuation amount.

Since the light source module 400 of the present embodiment includes the electro-optical element 100 of the first embodiment and the light source 30, the light source module 400 achieves a small amount of light being used as monitoring light and a high ratio of an intensity of output light to a light intensity input from the light source 30 to the optical-input-side optical waveguide 21 via the light input port 2a.

### Fifth Embodiment

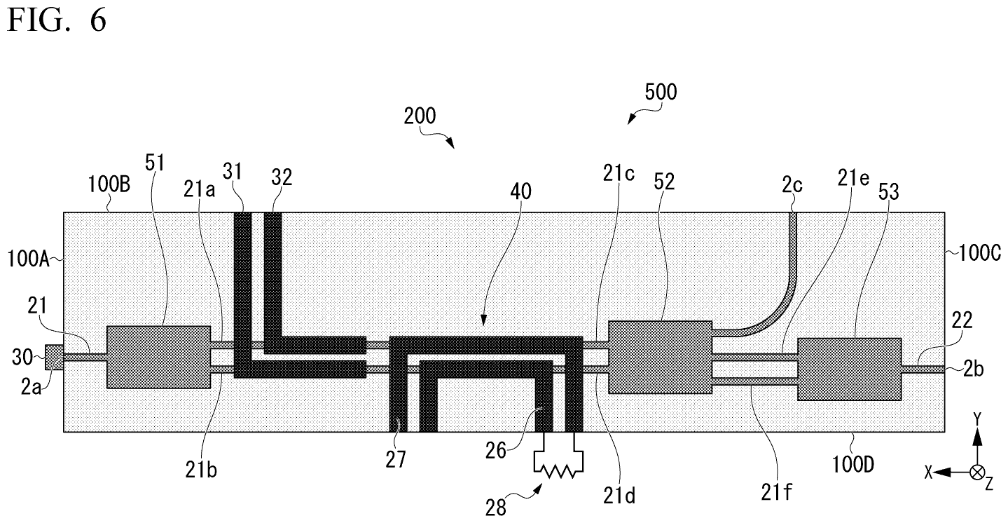

FIG. 6 is a schematic plan view illustrating a light source module according to a fifth embodiment including the electro-optical element 200 according to the second embodiment illustrated in FIG. 3. A light source module 500 of the present embodiment includes the electro-optical element 200 of the second embodiment and the light source 30.

As in the electro-optical element 100 of the light source module 400 illustrated in FIG. 5, the light source 30 illustrated in FIG. 6 emits light that is input from the light input port 2a and is guided through the optical-input-side optical waveguide 21. As the light source 30, a light source similar to the light source 30 of the light source module 400 can be used.

In the light source module 500 of the present embodiment, a current that is supplied to the light source 30 is preferably controlled according to the detection result of the light intensity fluctuation of the monitoring light guided through the monitoring optical waveguide 3 of the electro-optical element 200 with the control unit of the electro-optical element 200. In this case, with the control of the current that is supplied to the light source 30, the amount of light that is emitted from the light source 30 can be adjusted, and even if the modulated light fluctuates depending on the temperature and/or the DC drift amount, the intensity (amount) of light that is guided through that optical-modulation optical waveguides 21a, 21b, 21c, and 21d can be corrected according to the fluctuation amount.

Since the light source module 500 of the present embodiment includes the electro-optical element 200 of the second embodiment and the light source 30, the light source module 500 achieves a small amount of light being used as monitoring light and a high ratio of an intensity of output light to a light intensity input from the light source 30 to the optical-input-side optical waveguide 21 via the light input port 2a.

### Sixth Embodiment

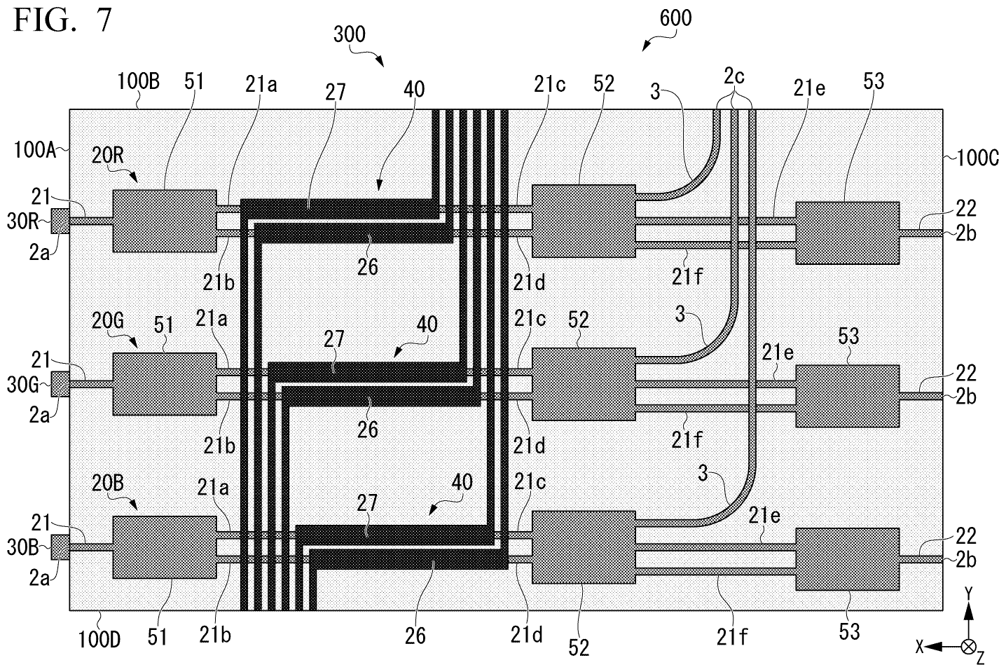

FIG. 7 is a schematic plan view illustrating a light source module according to a sixth embodiment including the electro-optical element 300 according to the third embodiment illustrated in FIG. 4. A light source module 600 of the present embodiment includes the electro-optical element 300 of the third embodiment and three light sources 30R, 30G, and 30B.

As illustrated in FIG. 7, the three light sources 30R, 30G, and 30B emit light that is input from the light input ports 2a of the optical modulation parts 20R, 20G, and 20B in the electro-optical element 300 and is guided through the optical-input-side optical waveguides 21, respectively.

As the light sources 30R, 30G, and 30B, a laser element such as a laser diode (LD) can be used. As the light source 30R, for example, various commercially available laser elements that emit red light having a peak wavelength equal to or greater than 610 nm and equal to or less than 750 nm can be used. As the light source 30G, for example, various commercially available laser elements that emit green light having a peak wavelength equal to or greater than 500 nm and equal to or less than 560 nm can be used. As the light source 30B, for example, various commercially available laser elements that emit blue light having a peak wavelength equal to or greater than 435 nm and equal to or less than 480 nm can be used.

In the light source module 600 of the present embodiment, a current that is supplied to each of the three light sources 30R, 30G, and 30B is preferably controlled according to the detection result of the light intensity fluctuation of the monitoring light guided through the monitoring optical waveguide 3 in each of the optical modulation parts 20R, 20G, and 20B of the electro-optical element 300 with the control unit of the electro-optical element 300. In this case, with the control of the current that is supplied to each of the three light sources 30R, 30G, and 30B, the amount of light that is emitted from each of the three light sources 30R, 30G, and 30B can be adjusted. Accordingly, in each of the optical modulation parts 20R, 20G, and 20B, even if the modulated light fluctuates depending on the temperature and/or the DC drift amount, the intensity of light guided through each of the optical-modulation optical waveguides 21a, 21b, 21c, and 21d can be corrected according to the fluctuation amount.

Since the light source module 600 of the present embodiment includes the electro-optical element 300 of the third embodiment and the light sources 30R, 30G, and 30B, the light source module 600 achieves a small amount of light being used as monitoring light and high ratios of an intensity of output light to intensities of light input from of the light sources 30R, 30G, and 30B to the optical-input-side optical waveguides 21 via the light input ports 2a.

### Optical Engine and XR Glasses

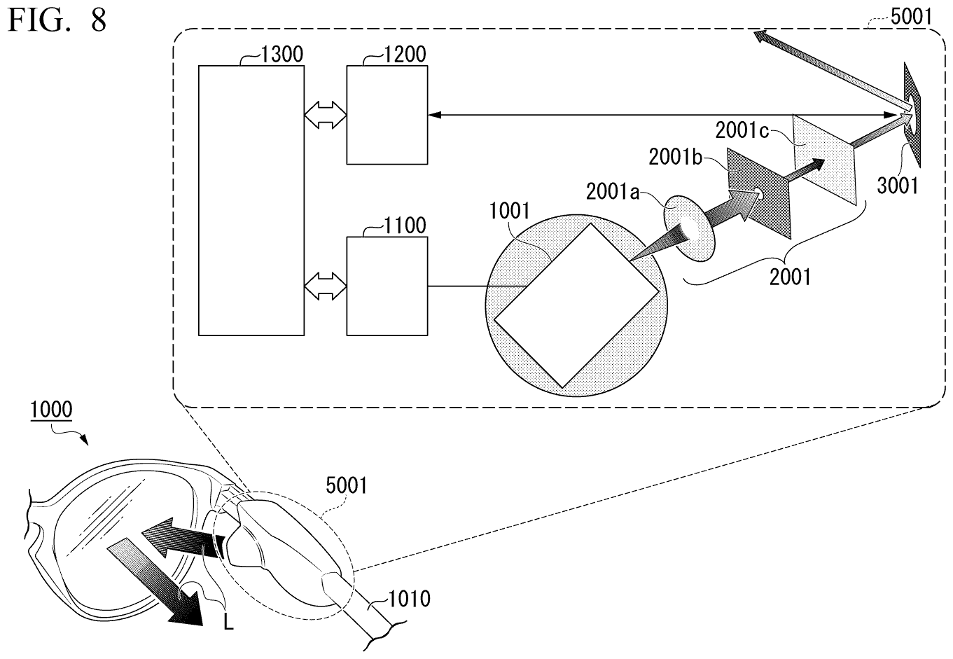

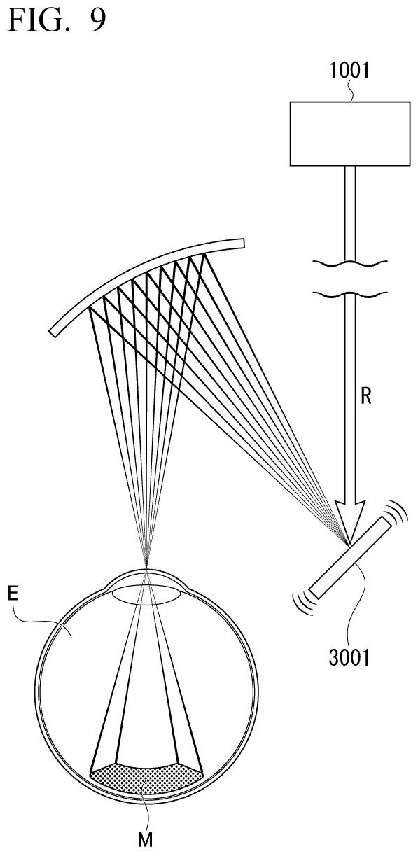

FIG. 8 is a conceptual diagram illustrating an example of XR glasses of the present invention. FIG. 9 is a conceptual diagram illustrating a manner in which an image is directly projected on a retina by laser light emitted from a light source module in the XR glasses illustrated in FIG. 8.

XR glasses (eyeglasses) 1000 of the present embodiment are a spectacles-type terminal. XR is a generic term for virtual reality (VR), augmented reality (AR), and mixed reality. Reference sign L illustrated in FIG. 9 represents image display light.

The XR glasses 1000 of the present embodiment illustrated in FIG. 8 has a light source module 1001 according to the above-described embodiment that is mounted in an optical engine 5001 provided in a frame 1010.

As illustrated in FIG. 8, the optical engine 5001 includes the light source module 1001, an optical scanning mirror 3001, an optical system 2001 that connects the light source module 1001 and the optical scanning mirror 3001, a laser driver 1100, an optical scanning mirror driver 1200, and a video controller 1300 that controls the drivers.

As the optical scanning mirror 3001, for example, a MEMS mirror can be used. To project a 2D image, as the optical scanning mirror 3001, a two-axis MEMS mirror that vibrates to change an angle in a horizontal direction (X direction) and a vertical direction (Y direction) and reflect laser light is preferably used.

The optical system 2001 optically processes laser light emitted from the light source module 1001. As the optical system 2001, for example, an optical system including a collimator lens 2001a, a slit 2001b, and an ND filter 2001c can be used. The optical system 2001 illustrated in FIG. 8 is an example, and other configurations may be employed.

In the XR glasses 1000 of the present embodiment illustrated in FIG. 8, as illustrated in FIG. 9, laser light R emitted from the light source module 1001 attached to the frame 1010 is reflected by the optical scanning mirror 3001, is further reflected by a lens of the XR glasses 1000, enters an eyeball E of a person as image display light L, and can project an image (video) directly on a retina M.

In the XR glasses 1000 of the present embodiment, since the light source module 1001 of the present embodiment is mounted, light emitted from the light source can be efficiently used.

Although the embodiments of the present invention have been described in detail with reference to the drawings, components in the embodiments and combinations thereof are exemplarily provided, and additions, omissions, substitutions, and other modifications may be made without departing from the spirit of the present invention.

### EXAMPLES

Hereinafter, the present invention will be described in more detail using examples. It should be noted that the present invention is not to be limited to the examples described below.

### Example 1

A simulation is performed on the optical coupling and branch part 52 in the electro-optical elements of the first embodiment to the third embodiment illustrated in FIGS. 1 to 3 under conditions described below. Fimmwave (Photon Design Corporation) is used as simulation software.

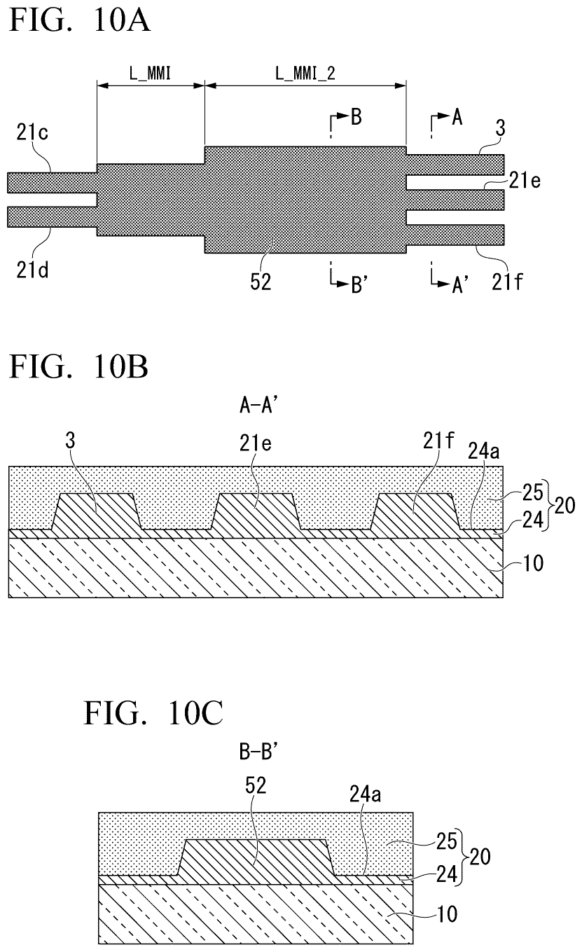

FIG. 10A is a plan view of the optical coupling and branch part 52 subjected to the simulation of Example 1 and optical waveguides connected thereto. FIG. 10B is a cross-sectional view taken along line A-A′ of FIG. 10A. FIG. 10C is a cross-sectional view taken along line B-B′ of FIG. 10A.

In FIGS. 10A to 10C, members corresponding to the members in the electro-optical elements illustrated in FIGS. 1 to 3 are represented by the same reference signs as those in FIGS. 1 to 3.

In the simulation of Example 1, all the optical-modulation optical waveguides 21c and 21d, the monitoring optical waveguide 3, and the optical-output-side optical waveguides 21e and 21f illustrated in FIGS. 10A to 10C have the same cross-sectional shape. Specifically, the optical waveguides are made of the optical waveguide core film 24 having a ridge-like shape, and have a trapezoidal cross-sectional shape in which a width of an upper base is 2 μm, a height is 0.7 μm, and an inclination angle of a side surface is 80°. The film thickness (the film thickness of the portion (slab portion) having no ridge-like shape) of the optical waveguide core film 24 is set to 0.15 μm. All of an interval between lower base centers of the two optical-modulation optical waveguides 21c and 21d, an interval between lower base centers of the two optical-output-side optical waveguides 21e and 21f, and an interval between lower base centers of the monitoring optical waveguide 3 and the optical-output-side optical waveguide 21e are set to 4 μm.

The cross-sectional shape of the optical coupling and branch part 52 is a trapezoidal cross-sectional shape in which a height is 0.7 μm and an inclination angle of a side surface is 80°. Lengths L_MMI and L_MMI_2 of the optical coupling and branch part 52 illustrated in FIGS. 10A and 10C are set to dimensions illustrated in Table 1 according to a wavelength of input light, a width of an upper base of a region having the length L_MMI is set to 8 μm, and a width of an upper base of a region having the length L_MMI_2 is set to 12 μm.

The substrate 10, the optical waveguide core film 24, and the optical waveguide cladding (buffer) film 25 illustrated in FIGS. 10A to 10C are made of materials described below.

### Materials

substrate 10; sapphire single-crystal substrate
optical waveguide core film 24; epitaxial film made of lithium niobate (LiNbO₃) film
optical waveguide cladding (buffer) film 25; SiO₂ film

In the simulation of Example 1, as illustrated in Table 1, three kinds of red light 637 nm, green light 520 nm, and blue light 455 nm are used as input light, and a ratio (output light intensity/input light intensity) of an output light intensity to an input light intensity of the optical coupling and branch part 52 and a ratio (monitoring light intensity/input light intensity) of a monitoring light intensity to the input light intensity are calculated.

The input light intensity is a sum of intensities of light input from the optical-modulation optical waveguides 21c and 21d to the optical coupling and branch part 52 illustrated in FIG. 10A. The output light intensity is a sum of intensities of light output from the optical coupling and branch part 52 to the optical-output-side optical waveguides 21e and 21f illustrated in FIG. 10A. The monitoring light intensity is a light intensity output from the optical coupling and branch part 52 to the monitoring optical waveguide 3 illustrated in FIG. 10A.

TABLE 1

| | | | Ratio of Monitoring | Ratio of Output |
|---|---|---|---|---|
| Wavelength | | | Light Intensity | Light Intensity |
| of Input | | | (Monitoring Light | (Output Light |
| Light | L_MMI | L_MMI_2 | Intensity/Input | Intensity/Input |
| (nm) | (nm) | (nm) | Light Intensity) | Light Intensity) |
| 637 | 115 | 170 | 0.30 | 0.62 |
| 520 | 127 | 222 | 0.30 | 0.59 |
| 455 | 134 | 280 | 0.36 | 0.65 |

As illustrated in Table 1, even if the input light is any of red light 637 nm, green light 520 nm, and blue light 455 nm, it is confirmed that, with the optical coupling and branch part 52 configured to branch the two optical-modulation optical waveguides 21c and 21d into one monitoring optical waveguide 3 and the two optical-output-side optical waveguides 21e and 21f, a ratio of an output light intensity to an input light intensity of the optical coupling and branch part 52 is high, about ⅔, and a ratio of a monitoring light intensity to the input light intensity is low, about ⅓.

### EXPLANATION OF REFERENCES

2a light input port
2b light output port
2c monitoring light output port
3 monitoring optical waveguide
10 substrate
10a main surface
20 optical functional layer
20R, 20G, 20B optical modulation part
21 optical-input-side optical waveguide
21a, 21b, 21c, 21d optical-modulation optical waveguide
21e, 21f optical-output-side optical waveguide
22 optical-output optical waveguide
24 optical waveguide core film
25 optical waveguide cladding (buffer) film
26, 27 electrode
28 termination resistor
30, 30R, 30G, 30B light source
31, 32 bias electrode
40 Mach-Zehnder optical modulation part
51 optical branch part
52 optical coupling and branch part
53 optical coupling part
100, 200, 300 electro-optical element
100A first side surface
100B second side surface
100C third side surface
100D fourth side surface
400, 500, 600, 1001 light source module
1000 XR glasses (eyeglasses)
1010 frame
1100 laser driver
1200 optical scanning mirror driver
1300 video controller
2001 optical system
2001a collimator lens
2001b slit
2001c ND filter
3001 optical scanning mirror
5001 optical engine

What is claimed is:

1. An electro-optical element comprising:
a substrate; and
an optical functional layer formed on a main surface of the substrate,
wherein the optical functional layer includes,
an optical-input-side optical waveguide configured to guide light emitted from a light source,
an optical branch part configured to branch the optical-input-side optical waveguide into two optical-modulation optical waveguides,
a Mach-Zehnder optical modulation part configured to modulate light guided through the two optical-modulation optical waveguides,
an optical coupling and branch part configured to branch the two optical-modulation optical waveguides configured to guide modulated light modulated by the Mach-Zehnder optical modulation part into one monitoring optical waveguide and a plurality of optical-output-side optical waveguides, and
an optical coupling part configured to make the plurality of optical-output-side optical waveguides as one optical-output optical waveguide.

2. The electro-optical element according to claim 1,
wherein all of the optical-input-side optical waveguide, the optical-modulation optical waveguides, the monitoring optical waveguide, the optical-output-side optical waveguides, and the optical-output optical waveguide are made of lithium niobate.

3. The electro-optical element according to claim 1,
wherein all of the optical branch part, the optical coupling and branch part, and the optical coupling part are multimode interferometers.

4. The electro-optical element according to claim 1,
wherein a number of the plurality of optical-output-side optical waveguides is two.

5. The electro-optical element according to claim 1, further comprising:
a photodetector configured to detect a light intensity fluctuation of monitoring light guided through the monitoring optical waveguide; and
a control unit configured to correct an intensity of light guided through the optical-modulation optical waveguides according to a detection result of the monitoring light in the photodetector.

6. The electro-optical element according to claim 1, wherein
the optical functional layer further includes a light input port through which the light emitted from the light source is input to the optical-input-side optical waveguide, and
the optical-input-side optical waveguide guides the light input from the light input port.

7. The electro-optical element according to claim 5, wherein
the optical functional layer further includes bias electrodes provided on the two optical-modulation optical waveguides disposed between the optical branch part and the Mach-Zehnder optical modulation part, respectively, and
a DC voltage that is applied from the bias electrodes to the optical-modulation optical waveguides is controlled by the control unit.

8. The electro-optical element according to claim 1, wherein
the optical functional layer includes,
three optical modulation parts each including the optical-input-side optical waveguide,
the optical branch part,
the Mach-Zehnder optical modulation part,
the optical coupling and branch part, and
the optical coupling part, and
the optical-input-side optical waveguides of the respective optical modulation parts guide light having different wavelengths.

9. A light source module comprising:
a light source; and
the electro-optical element according to claim 1.

10. A light source module comprising:
a light source; and
the electro-optical element according to claim 5,
wherein a current that is supplied to the light source is controlled by the control unit.

11. An optical engine in which the light source module according to claim 9 is mounted.

12. XR glasses in which the light source module according to claim 9 is mounted.
